(19) United States
(12) Patent Application Publication
(10) Pub. No.: US 2008/0222930 A1
(43) Pub. Date: Sep. 18, 2008

(54) Animal Ear Tag

(75) Inventors: Robert G. Pennington, Rayville, MO (US); Earl Shumate, Exceisior Springs, MO (US)

Correspondence Address: BAYER HEALTHCARE LLC, P.O.BOX 390, SHAWNEE MISSION, KS, 66201, US

(73) Assignee: BAYER HEALTHCARE LLC, TARRYTOWN, NY (US)

(21) Appl. No.: 12/064,314

(22) PCT Filed: Sep. 8, 2006
(86) PCT No.: PCT/US06/35205

§ 371 Date: Feb. 20, 2008

(30) Foreign Application Priority Data
Sep. 9, 2005 (US) 60715989

(51) Int. Cl. G09F 3/16

(52) U.S. Cl. 40/301

(57) ABSTRACT

An animal ear tag includes a tag body and a locking insert, wherein once the locking insert is placed within the boss of a receptacle of the body of the ear tag, the insert is not easily dislodged therefrom. In addition, the present invention relates to an animal ear tag and locking insert wherein the locking insert prevents separation of the locking components of the animal ear tag once the ear tag is installed on an animal, thereby inhibiting loss of the ear tag.

### CROSS-REFERENCE TO RELATED APPLICATIONS

This application claims priority to U.S. provisional patent application No. 60/715,989, filed Sep. 9, 2005, which is hereby incorporated by reference in its entirety.

### FIELD OF THE INVENTION

The present invention relates to an animal ear tag. In particular, the present invention relates to a locking insert for an ear tag, wherein the locking insert engages the ear tag thereby preventing separation of the insert from the ear tag.

### BACKGROUND OF THE INVENTION

Ear tags are used for identification and/or to protect animals from ectoparasites, such as Horn Flies, Face Flies, Gulf Coast Ticks, Spinose Ear Ticks, Stable Flies, Houseflies, and Lice. Protection results from the inclusion of insecticides in the ear tags, the insecticides being released over a period of time. Distribution of the insecticide occurs through the natural movement of the animal, such as through rubbing and/or shaking of the animal's head.

One type of ear tag currently being used includes a female component and a male component. The male component penetrates the ear of the animal and locks into the female component of the ear tag, to fasten the tag to the ear. The female component includes a boss and a tag member, with both typically being made of a plastic material, having an insecticide incorporated therewith. The male component is made of a resilient plastic so that when the male component is inserted into the female component it cannot be very easily disengaged. However, one problem associated with the female component of such tags relates to the softening of the plastic of the boss and tag member. The incorporated insecticide causes the plastic to soften, which can cause the male and female components to separate. To overcome problems with softening plastic, rigid plastic inserts can be placed inside the boss to provide a more rigid means of securing the head of the male component to the female component, so that the loss of ear tags is reduced.

The current rigid inserts address the problems of the softened plastic, however certain problems still remain. In particular, the rigid inserts occasionally separate from the boss during shipping or thereafter, often due to the natural shrinkage of the plastic, which can occur following molding. Once separated, the inserts can drop to the ground, where they are lost, making the ear tag unusable. Accordingly, a need exists for an ear tag whereby the rigid insert does not readily separate from the remainder of the ear tag.

### SUMMARY OF THE INVENTION

In accordance with one aspect of the invention, an insert to be received by an animal ear tag is provided. The insert includes a substantially tubular sidewall having an inner surface, an outer surface, and first and second opposed end portions. The sidewall defines a channel therethrough. A flange is arranged in the second end portion of the sidewall to be received by a mating element defined on the animal ear tag, to mutually engage the insert and the animal ear tag.

The insert, in accordance with this aspect of the invention, can further include a rim arranged in the first end portion of the sidewall, extending distally outwardly from the sidewall. Moreover, the sidewall can include an expanded thickness region or “rib” for increasing rigidity of the insert. Such expanded thickness region can extend from the flange to a rim arranged in the first end portion of the sidewall, and distally outwardly from the sidewall. A plurality of expanded thickness regions can be provided in the sidewall, and can be spaced equally about a circumference of the sidewall. The tubular wall of the insert can have a substantially circular cross-section.

If desired, an end wall can be arranged at a second end of the insert, the end wall extending radially inwardly from the sidewall, and having a central aperture defined therein. The rim can be arranged at a first end of the tubular wall and can extend about a circumference of the insert. The flange can be arranged at a second end of the tubular wall and can extend about a circumference of the insert and/or can include a plurality of circumferentially spaced flange portions.

The mating element of the ear tag can be a recess defined in a body of the ear tag and/or can be defined by a protrusion extending into a receptacle defined in the body of the ear tag. Preferably, the insert is made of a relatively rigid material, but one that is still flexible enough to allow flexure during insertion of a locking element therethrough. In one preferred embodiment, the insert is made of a plastic material, which is a polyethylene/polypropylene blend. In a further preferred embodiment, the insert is made of AP 6106-HS, available from Huntsman Corporation of Houston, Tex.

In accordance with another aspect of the invention, an animal ear tag is provided, which includes a tag body and an insert. The tag body has a receptacle defined therein, which in-turn has a first engagement means. The insert has a substantially tubular sidewall and a second engagement means for engaging the first engagement means of the tag body, to mutually engage the insert and the tag body. The sidewall of the insert has an inner surface, an outer surface, and first and second opposed end portions. The sidewall also defines a channel therethrough. In accordance with this embodiment, the insert can be more rigid than the tag body. Further, the tag body can include an ectoparasiticidal active compound.

The receptacle can be provided in a boss, with the boss being integrally formed with and extending from the tag body. The boss can include a channel defined therein, which passes through the tag body from a first side of the tag to a second side of the tag. The channel can terminate at a first aperture proximate the first side of the tag, and at a second aperture proximate the second side of the tag.

The receptacle of the tag can include a channel which passes through the tag body from a first side of the tag to a second side of the tag, for accepting a locking component to secure the ear tag to an animal. Further, a protective cover can be provided on a second side of the tag, for inhibiting tampering with engagement of a locking component and the insert, the locking component being inserted from the first side of the tag.

In accordance with the invention, the first engagement means can be a recess defined in a wall of the receptacle and the second engagement means can be a flange arranged in the second end portion of the sidewall to be received by a mating element, for example, a recess or groove, defined on the animal ear tag, to mutually engage the insert and the animal ear tag.

Alternatively or additionally, the second engagement means can be a plurality of flange portions arranged about a circumference of the sidewall in the second end portion, to be received by a mating element defined on the animal ear tag, to mutually engage the insert and the animal ear tag cross-section, or can have a substantially rounded square cross-section.

The subject animal ear tag can include at least one projection extending radially outwardly from the sidewall of the insert parallel to a longitudinal axis thereof, for increasing rigidity of the insert. Such projections can be provided on the sidewall of the insert, spaced at regular intervals about a circumference of the insert.

Further, a locking component can be provided for engaging the insert and/or the tag body of an animal tag in accordance with the invention. The locking component can include an elongate stem, a flange and a barbed tip portion. The flange can extend radially outwardly from a first end of the elongate stem to maintain attachment of the animal ear tag to an animal ear, and the button preferably has a diameter larger than a diameter of the stem. The barbed tip preferably extends from the second end of the elongate stem for piercing the animal ear, entering the channel defined by the insert, and engaging the insert to inhibit removal of the animal ear tag. The locking component can be separate from the remainder of the ear tag, prior to attachment therewith, or can be hingedly attached thereto.

In accordance with still another aspect of the invention, an animal ear tag is provided, which includes a tag body and an insert. The tag body has first and second opposed surfaces and a receptacle defined therein. The receptacle includes a sidewall and a substantially annular recess at a distal end thereof. The receptacle can be provided in a boss, extending from one of the first and second opposed surfaces of the tag body. The insert includes a sidewall and at least one flange extending therefrom. The sidewall is substantially tubular and has an inner surface, an outer surface, and first and second opposed end portions. Further, the sidewall defines a channel therethrough. The flange(s) extend(s) radially outwardly from the sidewall for engaging the substantially annular recess of the receptacle, to mutually engage the insert and the tag body.

In accordance with another aspect of the invention, a method of using an animal ear tag for controlling ectoparasites is provided. The steps include forming an animal ear tag and affixing the ear tag to an animal. The animal ear tag is formed by placing an insert into a receptacle of a body of the ear tag. The tag body includes an ectoparasiticidal active compound, and the receptacle includes a first engagement means. The rigid insert has a second engagement means for engaging the first engagement means of the tag body, to mutually engage the insert and the tag body. Finally, the method includes the step of affixing the ear tag to an animal with a locking component. Subsequently, insecticide is distributed to the animal over an extended period, controlling ectoparasites present on the animal. The extended period can be a period of about six months.

In accordance with still another aspect of the invention, a method of preparing an animal ear tag for attachment to an animal ear is provided. The method includes the steps of providing a tag body, providing an insert and placing the insert within a receptacle defined in the tag body. In accordance with this aspect, the receptacle includes a first engagement means, and the insert includes a substantially tubular sidewall having an inner surface, an outer surface, and first and second opposed end portions. The sidewall defines a channel therethrough. The insert also includes a second engagement means for engaging the first engagement means of the tag body, to mutually engage the insert and the tag body. In accordance with this aspect, the method can further include rotating the insert relative to the tag body, to mutually lock the insert and the tag body.

In accordance with another aspect of the invention, a method for attaching an ear tag to an animal is provided. The method includes the steps of providing an animal ear tag and tagging pliers, placing a locking component onto a pin of the tagging pliers, placing the animal tag onto a respective portion of the tagging pliers, locating a desired point on an ear of the animal, and compressing the tagging pliers to insert the locking component into the channel of the insert, thereby mutually engaging the locking component and the tag body. The animal ear tag includes a tag body having a receptacle defined therein, which in-turn includes a first engagement means. The ear tag also includes an insert having a substantially tubular sidewall having an inner surface, an outer surface, and first and second opposed end portions. The sidewall defines a channel therethrough. A second engagement means is provided in the insert for engaging the first engagement means of the tag body, to mutually engage the insert and the tag body. In accordance with this aspect, the method can also include the step of first placing the insert within the receptacle of the tag body.

It is to be understood that both the foregoing general description and the following detailed description are exemplary and are intended to provide further explanation of the invention claimed.

### BRIEF DESCRIPTION OF THE FIGURES

So that those having ordinary skill in the art will better understand how to make and use the ear tags and locking inserts of the subject invention, embodiments thereof will be described with reference to the drawings, wherein:

FIG. 1 is a side cross-sectional view of an animal ear tag according to a preferred embodiment of the present invention, illustrating the assembly of the tag body and a locking insert held within a receptacle of the tag body.

FIG. 1a is a side view of a locking male component of an animal ear tag according to the present invention including a flange, stem, and barb end.

FIG. 2 is a top view of the animal ear tag in accordance with the invention, having a tag body having a boss with an insert provided therein

FIG. 3 is a side cross-sectional view of a locking insert in accordance with the invention, having one outwardly projecting flange at one end and a radially outwardly projecting rim at the other end thereof.

FIG. 4 is a side cross-sectional view of a preferred locking insert in accordance with the invention, having an outwardly projecting flange around one end of the locking insert and an outwardly projecting rim around the other end of the locking insert.

FIG. 5 is a side cross-sectional view of a further locking insert in accordance with the invention, having one radially outwardly projecting rib, parallel to a longitudinal axis of the insert and arranged on the outer wall thereof, and an outwardly projecting rim around one end of the locking insert.

FIG. 6 is a side cross-sectional view of still another locking insert in accordance with the invention, having a plurality of projecting ribs, parallel to a longitudinal axis of the insert and arranged on the outer wall thereof, and an outwardly projecting rim around one end of the locking insert.

FIG. 7 is a side cross-sectional view of another locking insert in accordance with the invention, having a plurality of projecting ribs, parallel to a longitudinal axis of the insert and arranged on the outer wall thereof, an outwardly projecting rim around one end, and a plurality of radially outwardly projecting flanges at the other end thereof.

FIG. 8 is a side cross-sectional view of a boss of an ear tag constructed in accordance with the invention, having a receptacle with a contour to facilitate insertion of and engagement with the insert of FIG. 7.

FIG. 9 is a bottom view of an insert, in accordance with the invention, wherein the flange is a circular flange.

FIG. 10 is a bottom view of an insert in accordance with the invention wherein the flange is a substantially square flange, having rounded corners.

FIG. 10A is a top view of a receptacle in accordance with the invention adapted to engage the insert of FIG. 10.

FIG. 11 is a side cross-sectional view of a further insert in accordance with the invention, having locking protrusions for engagement with an ear tag.

FIG. 12 is a side view of the insert of FIG. 11.

FIG. 13 is a side cross-sectional view of a portion of an ear tag constructed in accordance with the invention, having a boss provided thereon, where the boss includes locking channels for engagement with the protrusions of the insert of FIG. 11.

FIG. 14 is a side cross-sectional view of a wall of an ear tag constructed in accordance with the invention, having a locking recess arranged in an end portion of a receptacle for receiving an insert.

FIG. 15 is a side cross-sectional view of an insert for insertion into the receptacle of FIG. 14, having a bottom wall, and a radially outwardly projecting flange both set back from an end of the insert.

FIG. 16 is a side cross-sectional view of an insert in accordance with the invention held in a boss of an ear tag constructed in accordance with the invention. The boss in this embodiment includes a stepped feature corresponding to a recess for engaging the insert.

FIG. 17 is a side cross-sectional view illustrating a further embodiment of an insert in accordance with the invention, wherein the insert extends through the wall of the ear tag and has a rim and flange, each on a respective side thereof.

FIG. 18 is a side cross-sectional view illustrating a further embodiment of an insert in accordance with the invention, wherein the insert includes a rim setback from an end of the sidewall of the insert. Further, the wall of the ear tag, within which the insert is held, includes a contoured increased thickness portion in which a locking channel is formed for engaging a flange of the insert.

FIG. 19 is a partial side cross-sectional view of an ear tag assembly in accordance with the invention, where a tamper-evident cover is provided over the insert and locking element thereof.

### DESCRIPTION OF THE PREFERRED EMBODIMENTS

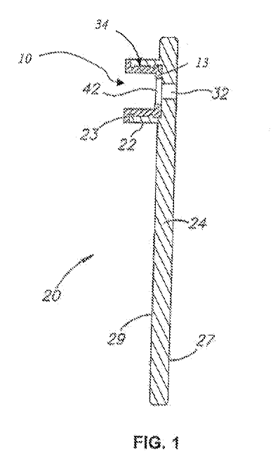

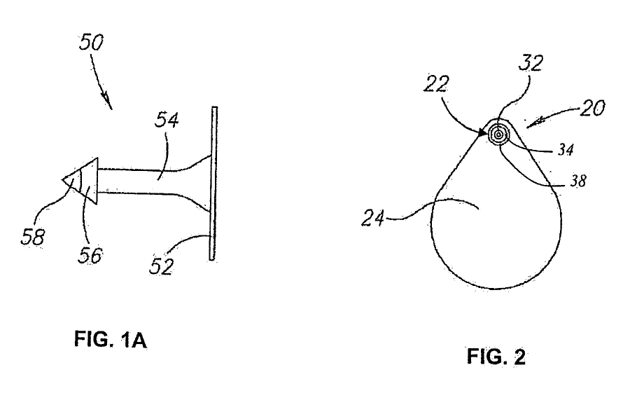

The present invention relates to an animal ear tag and to a locking insert therefor. As seen in FIG. 1, for example, the locking insert 34 is received by and held in a receptacle 10. The receptacle 10 can be provided in boss 22 extending from the body 24 of the ear tag 20. The insert and receptacle are shaped so that the insert 34 cannot be easily dislodged from the receptacle. In addition, the locking insert 34 of the present invention, once placed within the receptacle 10, will also inhibit a locking male component 50 (not shown) from becoming dislodged from the ear tag 20, which would cause loss of the ear tag 20. As such, a unique ear tag 20 and rigid insert 34 are provided, where the insert 34 and ear tag mutually engage one another to prevent unintentional dislodgement of the insert.

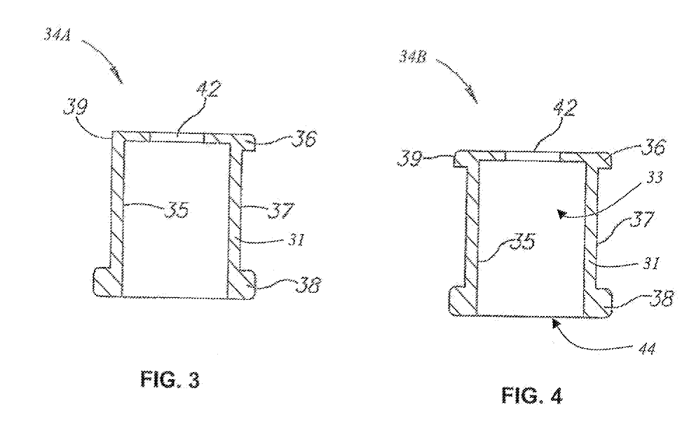

In the embodiment of FIGS. 1, 1A and 2, the ear tag 20 includes a body 24 with a first surface 29 and an opposed second surface 27. The ear tag also includes a boss 22, which is integrally formed with and extends from the first surface 29 of a tag body 24. As seen in FIG. 1, the boss 22 defines a receptacle 10, which receives the insert 34. A recess 13 formed in the boss 22, along the wall of the receptacle 10, engages a flange of the insert 34, to inhibit removal of the insert 34 therefrom. A more detailed description of inserts in accordance with the invention is found below, in connection with the description of FIGS. 3-7, 9-12, and 15-19.

FIG. 1A illustrates a male locking component 50, which is received and held by the ear tag body 24, and together with the ear tag body 24 inhibits removal of the ear tag 20 from an animal. The barbed end 56 of the locking component 50, in use, passes through an aperture 32 formed in the body 24 of the tag 20 and an aperture 42 formed in an end wall of the insert 34. The end 56 is generally conical in shape, having a sharp point at its tip, a tapered surface and an expanded diameter region opposite the point. The barbed end 56 can be made from a resilient material, such that it compresses during insertion. Once received through the apertures 32, 42, the barbed end 56 inhibits separation of the locking component 50 from the tag body 24. A stem 54 connects the end 56 to the opposite flange 52, which prevents the locking component 50 from pulling through the piercing of the animal ear, through which the stem 54 also passes. A reinforced tip 58, which can be made from a metal such as stainless steel, is used to pierce the ear of the animal to which the ear tag 20 is mounted. As can be seen in FIG. 1, the aperture 32 in the tag body 24, is preferably coaxially arranged with respect to the aperture 42 of the insert 34.

FIG. 2 is a top view of an ear tag 20 constructed in accordance with the invention. In this figure, a lobular shape of the tag body 24 is visible, although any shape tag can be provided, such as triangular, rectangular or hexagonal, for example. Additionally, the rim 38 of the insert 34, and aperture 32 of the tag body 24 are visible in this figure.

As shown in FIGS. 3-7, 9-12, and 15-19, inserts 34A-L in accordance with the invention may be of any of a variety of constructions, provided that the inserts are relatively more rigid than the tag body 24. The inserts are configured and adapted to be received and held by a receptacle (e.g., receptacle 10 of FIG. 1) defined within in the tag body 24 and/or within a boss on the tag body. Further, the inserts allow for passage of a barb end 56 (See FIG. 1A) of a locking member 50 (See FIG. 1A), for securing the tag to an animal. The construction of the locking insert is such that once inserted and received by a respective portion of the tag, the insert will not readily separate from the tag body. Inserts 34A-L in accordance with the invention have a substantially tubular configuration, and preferably also have a generally cylindrical cross-section. However, other configurations are possible, still in keeping with the spirit of the present invention.

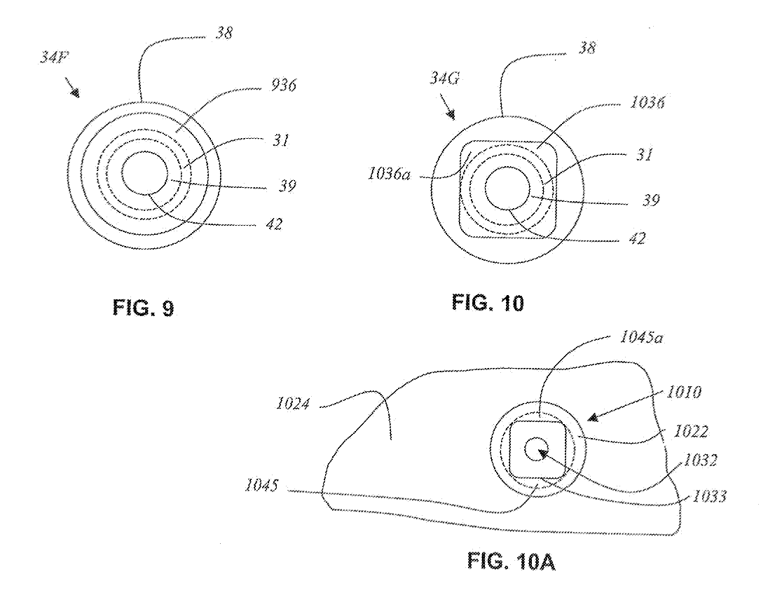

FIGS. 3-7 illustrate inserts 34A-E, respectively. Although referred to generally as “insert(s) 34,” it is to be understood that this reference refers to any embodiment of inserts 34A-E illustrated in FIGS. 3-7, respectively. As can be seen in FIGS. 3-4 and 7, one or more radially outwardly projecting flanges 36 can be integrally formed with, or alternatively, secured to the insert 34. These flange(s) are preferably arranged on the sidewall 31 of the insert 34 at or near an end wall 39 thereof. However, the flanges can be arranged at any point along the sidewall 31. If embodied as a single flange, the flange can be essentially continuous about the circumference of the insert 34. Such a flange can have a cross section of any shape desired, such as circular (FIG. 9) or square or triangular, for example. In a preferred embodiment, a flange 36 is provided that has an overall rounded square shape (FIG. 10). Alternatively, a single discrete or a plurality of discrete, spaced flanges can be provided. Such flanges can be spaced at regular intervals, for example, at every 90 degrees about the circumference of the insert 34. Additional variations of flanges and attachment means in accordance with the invention are described in connection with FIGS. 9-19, below.

A rim 38 is preferably provided on the sidewall 31 of the insert 34, at or near the end of the sidewall 31, preferably opposite the flange(s) 36, and also preferably projects radially outwardly from the sidewall 31. However, the rim can project inwardly, and even fully seal off its respective end of the insert, to provide a tamper-evident feature, if desired. The rim 38 contacts the end wall 23 of the boss 22 (FIGS. 1 and 8) when inserted in the receptacle 10 of the boss 22. In use, the rim 38 functions as a solid, reinforcing region, which can withstand the stresses applied by pliers during installation of the insert into the boss 22, as well as subsequent insertion of the locking component into the insert 34, to secure the animal ear tag to an animal. As illustrated, the rim 38 is typically substantially annular in configuration. Preferably, the rim 38 has an outer diameter that is substantially equal to or greater than an outer diameter of the boss 22, if the tag body is so-equipped. It should be noted, however that ear tags need not include a boss 22, as will be described in more detail below, in connection with other embodiments. However, in such instances, the rim 38 nevertheless serves to reinforce the insert 34, and help secure the insert to the tag body, for example, by helping prevent pull-through of the insert through the ear tag.

FIG. 3 illustrates an insert 34A in accordance with the invention having a single outwardly projecting flange 36, and a rim 38, extending about the full circumference of the insert wall 31, extending from the outer surface 37 of the wall 31.

FIG. 4 illustrates another embodiment of an insert 34B in accordance with the invention. The insert 34B includes a substantially cylindrical tubular sidewall 31 having an inner surface 35, and an outer surface 37, with apertures 42, 44 defined at opposite ends of the insert. The outer surface 37 of the wall 31 is generally of a cylindrical configuration, and in use, contacts an inner wall of a receptacle 10, which can be in the boss 22. A flange 36 projects radially outwardly from the outer surface 37 of the sidewall 31, and engages a mating element in a tag body, such as a recess or groove defined in the wall thereof. The inner surface 35 defines a channel 33, through which a locking male component 50 (See FIG. 1A) can pass. Once in position, the locking male component 50 remains in the channel 33 and engages the insert 34B, to inhibit removal of the ear tag.

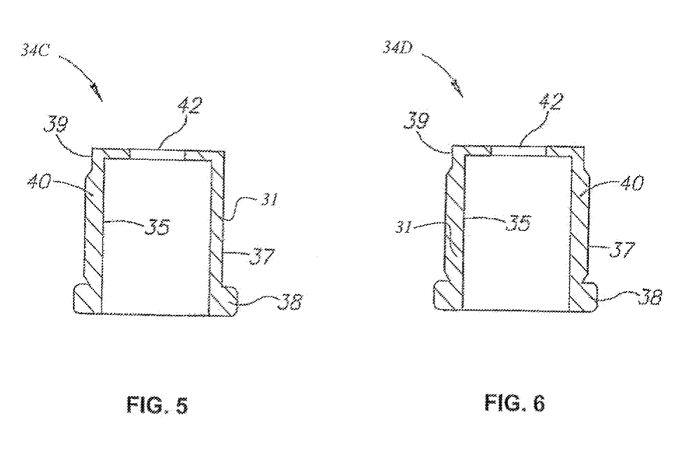

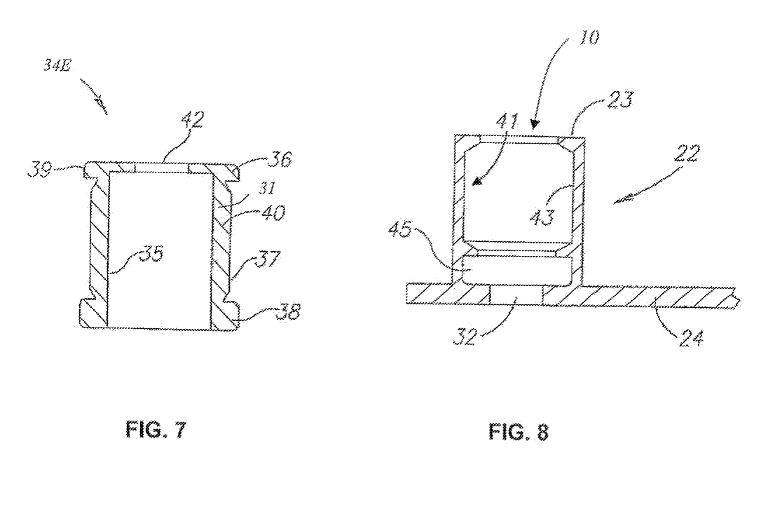

As can be seen in FIGS. 5-7, one or more reinforcing expanded-thickness portions, or ribs 40 can be provided on the outer surface 37 of the wall 31 of the inserts 34, such ribs 40 being arranged longitudinally between the flange 36, if provided, and the rim 38. The ribs 40 preferably run parallel to the longitudinal axis of the insert 34. Insert 34C of FIG. 5 includes a single reinforcing rib 40, while inserts 34D and 34E of FIGS. 6 and 7, respectively include a plurality of reinforcing ribs 40. Such ribs 40 can be arranged about the circumference of the wall 31 of the insert 34, at regular intervals. For example, four ribs 40 can be provided, each placed 90 degrees from the adjacent rib 40. Alternatively still, the rib can extend fully about the circumference of the wall 31, thereby constituting an expanded thickness portion of the wall. The rib(s) 40, if provided, increase the rigidity of the insert 34, increasing resistance to compression during attachment of the subject animal ear tag to an animal. Thus, chance of loss of the insert 34 and/or the entire ear tag 20 is reduced.

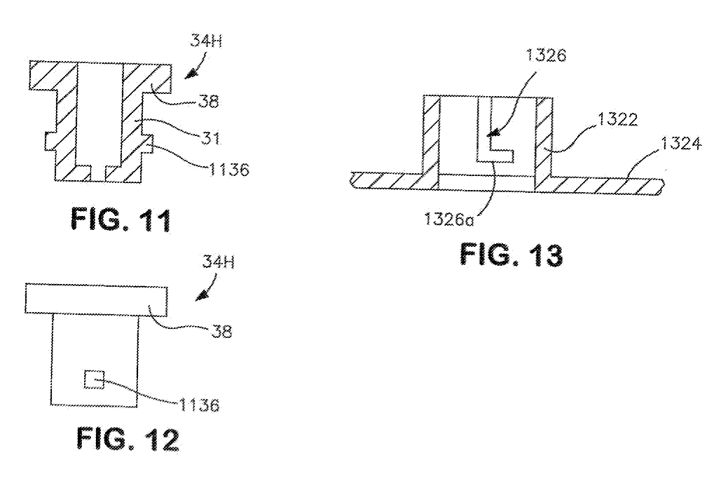

As shown in FIG. 8, which is a cross-sectional view of a boss 22 defining a receptacle 10 therein, the one or more ribs 40, if provided, are received by one or more matching recesses 41, provided along the interior wall 43 of the boss 22. In order to match corresponding configurations of inserts, the recess(es) 41 can extend fully about the inner circumference of the boss 22, or alternatively, can include a plurality of slots defined in the wall 43. If so-embodied, animal ear tags having such features can thus prevent separation of the insert 34 from the boss 22. Such features can be incorporated in place of, or in addition to, the aforementioned flange elements, such as flange 36 of FIG. 7. Preferably, the insert and receptacle 10 include one of the mechanical interlocking features set forth above, namely one or more flanges 36 or projecting ribs 40. For example, while insert 34C of FIG. 5 and insert 34D of FIG. 6 do not include one or more flanges, such as flange 36 of FIG. 4, the inserts 34C and 34D do include at least one projecting rib 40, which help engage the body of a tag, in accordance with the invention. Alternatively still, additional mechanical interlocking means can be used. For example, FIGS. 11-13 illustrate an insert 1134 and boss 1322, having a bayonet-type connection. This embodiment will be described in more detail below.

FIG. 9 is a bottom view of an insert 34F, in accordance with the invention, wherein the flange 936 is a circular flange. Such circular flange 936 can be incorporated into any of the foregoing or any of the following embodiments. Such flange 936 is received by an annular recess or groove defined in the wall of a receptacle formed in a tag body. It should be noted that such a recess or groove can be defined by a depression formed in a wall of a receptacle of a tag body, or can be defined by a raised area extending from the receptacle wall. As used herein, the terms “groove” and “recess” are intended to include such variations. As can be seen, an aperture 42 defined in the end wall 39 of the insert 34F allows passage of a locking component therethrough. The relative position of the sidewall 31, with respect to the flange 936, is shown in dashed lines.

FIG. 10 is a bottom view of an insert in accordance with the invention wherein the flange 1036 is a substantially square flange, having rounded corners. The flange 1036 extends from the sidewall 31 of the insert 34G, and thus includes corner portions 1036a, which extend from the sidewall 31 more than the remainder of the flange 1036. Due to the shape of the flange 1036, and the corner portions 1036a, when provided with and inserted into a similarly shaped receptacle in an ear tag body, the insert 34G can be rotated relative to the receptacle, for example by 90 degrees, thereby locking the insert into the receptacle. For example, preferably used in conjunction with this embodiment, is a receptacle, such as receptacle 1010 shown in FIG. 10A.

The receptacle 1010 of FIG. 10A is defined by a boss 1022, which extends from a surface of a tag body 1024 having a channel 1033 defined therethrough, which closely matches the size and shape of the flange 1036 of the insert 34G. A recess 1045 is provided within the boss 1022, and is substantially circular in configuration, having a diameter substantially equal to the length of a diagonal dimension of the square flange 1036. Accordingly, when the insert 34G is placed in the receptacle 1010, the insert 34G can be rotated by a predetermined amount, such that the corner portions 1036a rotate to be in arc-shaped segments 1045a of the recess 1045. Since the channel 1033 is substantially square, the insert 34G cannot be easily removed without rotating the insert 34G to a position where the square flange 1036 aligns with the square channel 1033. Following insertion, the aperture 1032 in the body 1024 and the aperture 42 of the insert 34G allow passage of a locking component therethrough, for attachment to an animal ear. Alternatively, an insert and receptacle can be provided having a similar shape, where relative rotation is not needed to lock the components together.

FIGS. 11 and 12 are side cross-sectional and side plan views, respectively, of a further insert 34H, constructed in accordance with the invention, having locking protrusions for engagement with a body 1324 of an ear tag, a portion of which is illustrated in cross-section in FIG. 13.

As with foregoing embodiments, the insert 34H includes a rim 38 at one end of a substantially tubular sidewall 31. However, in place of the above-described flanges, such as flanges 36 of FIG. 4, protrusions 1136 are instead provided. The protrusions can be provided in any number, but preferably provided in a quantity of between 1 and 4, spaced at regular intervals—180, 120 or 90 degrees for two, three or four protrusions, respectively. In the embodiment illustrated, two protrusions 1136 are provided on the sidewall 31 of the insert 34H, each at 180 degrees from the other, with respect to a longitudinal axis of the insert 34H. To attach the insert 34H to the body 1324 of an ear tag, the user must simply align each protrusion 1136 with a respective L-shaped groove 1326. The user then urges the insert 34H axially until the protrusions 1136 reach the bottom wall 1326a of the L-shaped groove 1326, at which point the user must rotate the insert 34H, with respect to the body 1324. Once fully engaged, direct axial removal is inhibited, removal first requiring rotation of the insert 34H.

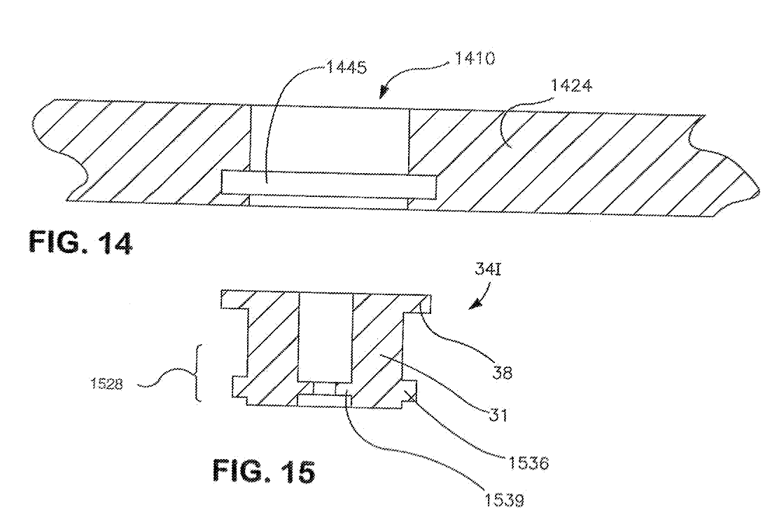

FIG. 14 is a side cross-sectional view of a body wall 1424 of an ear tag constructed in accordance with the invention, having a locking recess 1445 arranged in an end portion of a receptacle 1410 for receiving the insert 34I of FIG. 15. The insert 34I has a bottom wall 1539, and a radially outwardly projecting flange 1536, each of which is set back from an end of the insert. As can be seen, therefore, neither the flange (or flanges) 1536 nor the bottom wall 1539 need be provided at an end of a sidewall 31 of an insert 34I. Furthermore, while the flange 1536 is still provided in an end region 1528 of the insert 34I, this also need not be the case. Alternatively, the flanges 1536 can be placed at any position along the sidewall 31 of the insert 34I, provided that there is a mating feature in the body 1424 of the ear tag with which it is to be used.

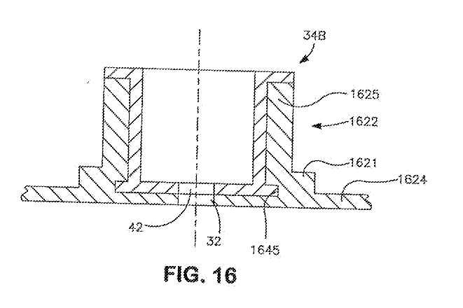

FIG. 16 is a side cross-sectional view of an insert 34B (also shown in FIG. 4) in accordance with the invention, held in a boss 1622 of an ear tag body 1624 constructed in accordance with the invention. The boss 1622 in this embodiment includes a stepped feature 1621 corresponding to an internal a recess 1645 for engaging the insert. Such stepped feature 1621 provides the requisite strength of the boss 1622, while allowing for the necessary engagement recess 1645, which would otherwise weaken the wall 1625 of the boss 1622. As also can be seen in FIG. 16, the central apertures 32, 42 of the body 1624 and insert 34B, respectively, axially align with one another. Accordingly, setback of inserts, with respect to an aperture formed in a tag body, which is apparent from the embodiment of FIG. 1, is optional.

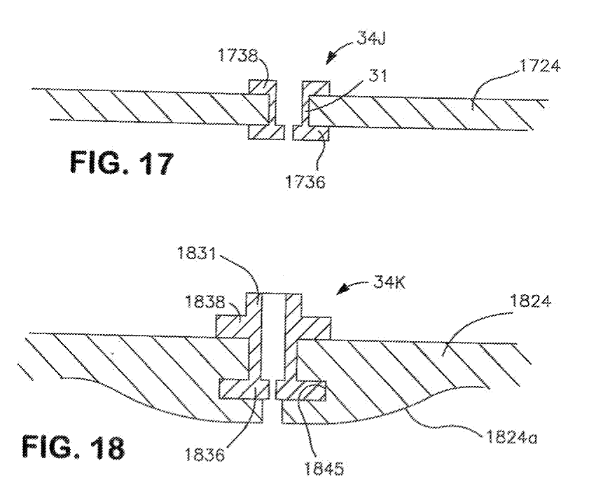

FIG. 17 is a cross-sectional view illustrating a further embodiment of an insert 34J constructed in accordance with the invention. The insert 34J extends fully through the wall of the ear tag body 1724. The insert 34J has a rim 1738 on a first end thereof, and a flange 1736 on the opposite end of the sidewall 31. Thus, the insert 34J is secured to the tag body 1724, resisting accidental removal therefrom.

FIG. 18 is a cross-sectional view illustrating a further embodiment of an insert 34K in accordance with the invention. The insert 34K, includes a rim 1838 setback from an end of the sidewall 1831 of the insert 34K. Further, the wall of the ear tag 1824, within which the insert 34K is held, includes a contoured increased thickness portion 1824a, in which a locking recess 1845 is formed, for engaging a flange 1836 of the insert 34K.

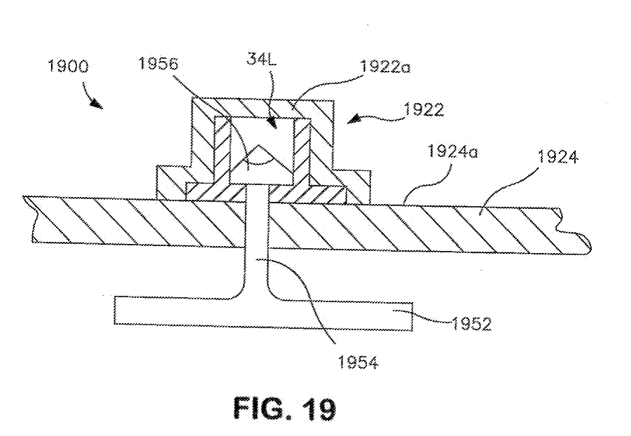

FIG. 19 is a partial cross-sectional view of an ear tag assembly 1900 in accordance with the invention. In this embodiment, a tamper-evident cover 1922a is provided over the insert 34L, and male locking component 1956 thereof. The tamper-evident cover 1922a is, in this embodiment, a continuation of the boss 1922. In this embodiment, the insert 34L does not include a rim (e.g., rim 38 of the embodiment of FIG. 4) and the boss 1922 is closed at the end distal to the tag body 1924. The boss extends from a surface 1924a of the body 1924, and surrounds the insert 34L, defining a receptacle for the insert 34L. To facilitate insertion of the insert 34L, the boss 1922 can be applied to the body 1924 over the insert 34L. The boss 1922 can be attached by way of ultrasonic, heat, friction or solvent welding, or by an adhesive, for example.

If the user desires to remove the ear tag of FIG. 19 from an animal after the ear tag has been attached to the animal, the user must sever the stem 1954 of the locking component, thereby leaving the barbed head 1956, and portion of the stem 1954 within the boss 1922 and locking insert 34L. The barbed head 1956 and portion of the stem 1954, which therefore remain in the boss 1922 prevents the insertion of a second male component into the boss, effectively preventing the reattachment of the ear tag to another animal. The flange 1952 of the locking component, however, is removed and the tag can be removed from the animal ear.

The animal ear tags of the present invention may be used for a variety of animals including cattle, pigs, goats, sheep, and any other animal on which an ear tag may be used.

The body of an animal ear tag in accordance with the invention, is generally made of a lightweight material such as a plastic. For example, materials used may include a polymer such as a urethane resins, vinyl resins, acrylic resins, epoxy resins, and the like. The tag component 24 may contain an insecticide ingredient, may include identification marks, or may include both the insecticide ingredient and the identification marks. In addition, the ear tag may be color coded to distinguish the insecticide included in the ear tag or simply as an identification distinction. Additionally, reflective elements, such as light-reflective pigments can be included to facilitate identification of tagged animals at night.

Further, if desired, a RFID (radio frequency identification) transponder can be incorporated into ear tags in accordance with the invention. The transponder can be placed in any portion of the ear tag, including the body of the ear tag, or the flange of the locking component, for example, flange 1952 in FIG. 19.

Ear tags in accordance with the present invention preferably include at least one insecticide or ectoparasiticidal active compound included within or coated onto the polymeric ear tag. Such an ear tag is used as a method of eliminating, treating or controlling ectoparasites, such as Horn Flies, Face Flies, Gulf Coast Ticks, Spinose Ear Ticks, Lice, Stable Flies and House Flies, on animals.

Various insecticidal compositions, including one or both of liquid and solid compositions, can be employed in association with the polymers noted above. For example, the ectoparasiticidal active compound may be an organophosphate or a pyrethroid, alone, or in combination with, for example, piperonyl butoxide. Suitable organophosphate insecticides include O,O-diethyl O-2-isopropyl-6-methylpyrimidin-4-yl phosphorothioate, commonly known as diazinon; S-1,2-bis(ethoxycarbonyl)ethyl O,O-dimethyl phosphorodithioate, commonly known as malathion; O,O-dimethyl O-4-nitro-m-tolyl phosphorothioate, commonly known as Sumithion®, sold by Sumitomo Chemical Co. Ltd; O,O,O,O′-tetraethyl S,S′-methylene bis(phosphorodithioate), commonly known as ethion; O,O-diethyl 0-(3,5,6-trichloro-2-pyridyl)phosphorothioate, commonly known as chlorpyrifos; O,O-diethyl 0-(3-chloro-4-methyl-2-oxo-2H-1-benzopyran-7-yl)phosphorothioate, commonly known as coumaphos; O-2-diethylamino-6-methylpyrimidin-4-yl O,O-dimethyl phosphorothioate, commonly known as pirimiphos-methyl, and mixtures thereof.

Suitable pyrethroid insecticides include, for example, zetacypermethrin; cyano(3-phenoxyphenyl)methyl 4-chloro-α-(1-methylethyl)benzeneacetate, commonly known as fenvalerate, and the active isomer thereof commonly known as esfenvalerate; cyano(3-phenoxyphenyl)methyl 3-(2,2-dichloroethenyl)-2,2-dimethylcyclopropanecarboxylate, commonly known as cypermethrin; (3-phenoxyphenyl)methyl 3-(2,2-dichloroethenyl)-2,2-dimethylcyclopropanecarboxylate, commonly known as permethrin; (3-phenoxyphenyl)methyl 2,2-dimethyl-3-(2-methyl-1-propenyl)cyclopropanecarboxylate, commonly known as phenothrin; cyano(4-fluoro-3-phenoxyphenyl)methyl 3-(2,2-dichloroethenyl)-2,2-dimethylcyclopropanecarboxylate, commonly known as cyfluthrin; [1α,3α(Z)]-(±)-cyano-(3-phenoxyphenyl)methyl 3-(2-chloro-3,3,3-trifluoro-1-propenyl)-2,2-dimethylcyclopropanecarboxylate, commonly known as cyhalothrin; [1α(S*),3α(Z)]-(±)-cyano-(3-phenoxyphenyl)methyl 3-(2-chloro-3,3,3-trifluoro-1-propenyl)-2,2-dimethylcyclopropanecarboxylate, commonly known as lambda-cyhalotrin; cyano(3-phenoxyphenyl)methyl-2,2-dimethyl-3-(2-methyl-1-propenyl)cyclopropanecarboxylate, commonly known as cyphenothrin; (RS)-cyano-(3-phenoxyphenyl)methyl (S)-4-(difluoromethoxy)-α-(1-methylethyl)benzeneacetate, commonly known as flucythrinate; cyano (3-phenoxyphenyl)methyl 2,2-dimethyl-3-(1,2,2,2-tetrabromoethyl)cyclopropanecarboxylate, commonly known as tralomethrin; [1α,3α(Z)]-(±)-(2-methyl[1,1′-bipheny]-3-yl)methyl 3-(2-chloro-3,3,3-trifluoro-1-propenyl)-2,2-dimethylcyclopropanecarboxylate, commonly known as bifenthrin, and mixtures thereof.

Alternatively, the active component is preferably two or more ectoparasiticidal active compounds comprising an organophosphate in combination with one or more pyrethroids. To the extent that the ectoparasiticidal active compounds may exist as optical or geometric isomers, all isomers and racemic mixtures are understood to be included herein. All possible other isomeric forms of the compounds are also included herein.

The ectoparasiticidal active compound should be present in the device which is attached to the animal in an ectoparasiticidal effective quantity, normally at least approximately 3% by weight (based on final product) with levels up to approximately 70% by weight being acceptable. Thus, the polymeric component will be present from 30% to 97% by weight of the final product. The ectoparasiticidal active compound, if liquid, may be introduced into the resin by a heating, absorption process, or if solid, it may first be dissolved in a volatile solvent, such as acetone, methyl ethyl ketone, methylene chloride and the like, followed by soaking in the polymer and removal of the solvent, for example. Generally a blending time of thirty minutes in a high intensity mixer will produce a homogeneous, free flowing, polymer/insecticide mixture (called a “dry blend”).

It is, of course, to be understood that ultraviolet light stabilizers such as 2-(2′-hydroxy-5′-methyl phenyl)-benzotriazole, fillers, lubricants, dyes, antioxidants such as octadecyl 3,5-di-tert-butyl-4-hydroxy-hydrocinnamate, pigments, and other inert ingredients may be incorporated into the formulation from zero to 2% by weight of the final product for serving their accepted functions which are well known to those skilled in the art. The active ingredient and any other ingredients may be formed into an ear tag, by any method generally known in the art, such as extrusion, injection molding, or compression molding.

The locking insert 34 of the present invention is preferably made of relatively rigid plastic material, in particular of a more rigid material than the materials used for the tag body of the animal ear tag. The relatively more rigid locking insert 34 provides the added strength support to the tag body and/or female component or receptacle of the animal ear tag, and additionally helps prevent the male locking component from disengaging from the female component/receptacle. The locking insert 34 can be made of any suitable material that is strong and rigid enough to retain the head 56 of the male locking component 50 within the locking insert 34. For example, the locking insert 34 may be made from polyurethanes, nylon-6, acetal resins, copolymer blends of polyurethane and polypropylene, or other thermoplastics. In addition, the locking insert 34 may be reinforced with a suitable strengthening material such glass fiber. Other comparable materials may also be used. Preferably, the modulus of elasticity of the material used to form the insert is low enough to provide for slight flexure, to allow a male locking member to pass therethrough, but high enough so that the male locking member is not easily removable from the insert, once inserted. In one preferred embodiment, the insert is made of a plastic material, which is a polyethylene/polypropylene blend. In a further preferred embodiment, the insert is made of AP 6106-HS, available from Huntsman Corporation of Houston, Tex.

Prior to using the animal ear tag of the present invention, the locking insert is placed inside the boss and then the tag body, having a female component, or receptacle defined thereon, is affixed to the animal using the locking male component. The insertion of the insert 34 into the receptacle can be effected during manufacture or alternatively, can be effected by a user prior to application of the ear tag to the animal. After the animal ear tag is affixed to the animal, the pesticide, if included, will be distributed over a period of time. Typically, the pesticide will be distributed over 6 months.

A method of attaching an ear tag to an animal is provided in accordance with the invention. Such method includes the steps of:

(a) Providing an animal tag in accordance with the invention, as described in detail above.

(b) Providing tagging pliers for attachment of the ear tag. Such tagging pliers can be any suitable pliers that are capable of engaging the locking male component with the receptacle and/or insert. Such pliers can be, for example, a Universal Total Tagger sold by Allflex USA, Inc., 2805 East 14th Street, Dallas, Tex.

(c) Placing a locking male component onto a pin of the tagging pliers.

(d) Placing the animal tag onto a respective portion of the tagging pliers. Such position is typically underneath a clip of the pliers, which holds the tag during application thereof.

(e) Locating a desired point on an ear of the animal.

(f) Compressing the tagging pliers to insert the locking component into the channel of the insert, thereby mutually engaging the locking component and the tag body. Further, the pliers are then withdrawn from the tag and the animal.

Additionally, if the inserts are provided separately, to be inserted into the tag by the user, the method can further include the step of first placing the insert within the receptacle of the tag body.

In view of the above, it will be seen that the several objects of the invention are achieved and other advantageous results attained.

When introducing elements of the present invention or the preferred embodiment(s) thereof, the articles “a,” “an,” and “the” are intended to mean that there are one or more of the elements. The terms “comprising,” “including” and “having” are intended to be inclusive and mean that there may be additional elements other than the listed elements.

While the present invention has been described in terms of specific embodiments thereof, it will be understood that no limitations are intended thereby to the details of construction or design, the present invention contemplating and including any novel feature or novel combination of features which are herein disclosed.

What is claimed is:

1. An insert to be received by an animal ear tag, the insert comprising:
(a) a substantially tubular sidewall having an inner surface, an outer surface, and first and second opposed end portions, the sidewall defining a channel therethrough; and
(b) a flange arranged in the second end portion of the sidewall to be received by a mating element defined on the animal ear tag, to mutually engage the insert and the animal ear tag.

2. The insert of claim 1, further comprising a rim arranged in the first end portion of the sidewall, extending distally outwardly from the sidewall.

3. The insert of claim 1, wherein the sidewall includes an expanded thickness region for increasing rigidity of the insert.

4. The insert of claim 3, wherein the expanded thickness region extends from the flange to a rim arranged in the first end portion of the sidewall, extending distally outwardly from the sidewall.

5. The insert of claim 3, wherein a plurality of expanded thickness regions are provided in the sidewall, spaced equally about a circumference of the sidewall.

6. The insert of claim 1, further comprising an end wall arranged at a second end of the insert, the end wall extending radially inwardly from the sidewall, and having a central aperture defined therein.

7. The insert of claim 1, wherein the rim is arranged at a first end of the tubular wall.

8. The insert of claim 1, wherein the flange is arranged at a second end of the tubular wall.

9. The insert of claim 1, wherein the mating element of the ear tag is a recess defined in a body of the ear tag.

10. The insert of claim 1, wherein the mating element of the ear tag is defined by a protrusion extending into a receptacle defined in the body of the ear tag.

11. The insert of claim 1, wherein the flange extends about a circumference of the insert.

12. The insert of claim 1, wherein the flange includes a plurality of circumferentially spaced flange portions.

13. The insert of claim 1, wherein the rim extends about a circumference of the insert.

14. The insert of claim 1, wherein the substantially tubular wall has a substantially circular cross-section.

15. The insert of claim 1, wherein the insert is made of a plastic material, the plastic material being a polyethylene/polypropylene blend

16. An animal ear tag, comprising:
(a) a tag body having a receptacle defined therein, the receptacle including a first engagement means; and
(b) an insert having:
(i) a substantially tubular sidewall having an inner surface, an outer surface, and first and second opposed end portions, the sidewall defining a channel therethrough; and
(ii) a second engagement means for engaging the first engagement means of the tag body, to mutually engage the insert and the tag body.

17. The animal ear tag of claim 16, wherein the insert is more rigid than the tag body.

18. The animal ear tag of claim 16, wherein the receptacle is provided in a boss, the boss being integrally formed with and extending from the tag body.

19. The animal ear tag of claim 18, wherein the boss includes a channel defined therein, which passes through the tag body from a first side of the tag to a second side of the tag.

20. The animal ear tag of claim 19, wherein the channel terminates at a first aperture proximate the first side of the tag, and terminates in a second aperture proximate the second side of the tag.

21. The animal ear tag of claim 16, wherein the receptacle includes a channel, which passes through the tag body from a first side of the tag to a second side of the tag, for accepting a locking component to secure the ear tag to an animal.

22. The animal ear tag of claim 21, wherein a protective cover is provided on a second side of the tag, for inhibiting tampering with engagement of a locking component and the insert, the locking component being inserted from the first side of the tag.

23. The animal ear tag of claim 16, wherein the first engagement means is a recess defined in a wall of the receptacle.

24. The animal ear tag of claim 16, wherein the second engagement means is a flange arranged in the second end portion of the sidewall to be received by a mating element defined on the animal ear tag, to mutually engage the insert and the animal ear tag.

25. The animal ear tag of claim 24, wherein the flange has a substantially circular cross-section.

26. The animal ear tag of claim 24, wherein the flange has a substantially rounded square cross-section.

27. The animal ear tag of claim 16, wherein the second engagement means is a plurality of flange portions arranged about a circumference of the sidewall in the second end portion, to be received by a mating element defined on the animal ear tag, to mutually engage the insert and the animal ear tag.

28. The animal ear tag of claim 16, further comprising at least one projection extending radially outwardly from the sidewall of the insert parallel to a longitudinal axis thereof, for increasing rigidity of the insert.

29. The animal ear tag of claim 28, wherein a plurality of projections are provided on the sidewall of the insert, spaced at regular intervals about a circumference of the insert.

30. The animal ear tag of claim 16, further comprising a locking component for engaging the insert, the locking component comprising:
(a) an elongate stem having a first end and a second end;
(b) a flange extending radially outwardly from the first end of the elongate stem to maintain attachment of the animal ear tag to an animal ear, the button having a diameter larger than a diameter of the stem; and
(c) an barbed tip extending from the second end of the elongate stem for piercing the animal ear, entering the channel defined by the insert, and engaging the insert to inhibit removal of the animal ear tag.

31. The animal ear tag of claim 30, wherein the locking component is separate from the remainder of the ear tag, prior to attachment therewith.

32. The animal ear tag of claim 16, wherein the tag body comprises an ectoparasiticidal active compound.

33. An animal ear tag, comprising:
(a) a tag body having first and second opposed surfaces and a receptacle defined therein, the receptacle including a sidewall and a substantially annular recess at a distal end thereof; and
(b) an insert having:
(i) a substantially tubular sidewall having an inner surface, an outer surface, and first and second opposed end portions, the sidewall defining a channel therethrough; and
(ii) at least one flange extending radially outwardly from the sidewall for engaging the substantially annular recess of the receptacle, to mutually engage the insert and the tag body.

34. The animal ear tag of claim 33, wherein the receptacle is provided in a boss, extending from one of the first and second opposed surfaces of the tag body.

35. A method of controlling ectoparasites in an animal by applying the ear tag of claim 16 to the animal.

36. A method of using an animal ear tag for controlling ectoparasites, the method comprising:
(a) forming an animal ear tag having an insecticide therein, the animal ear tag formed by placing an insert into a receptacle of a body of the ear tag, the tag body comprising an ectoparasiticidal active compound, the receptacle including a first engagement means; and the rigid insert having a second engagement means for engaging the first engagement means of the tag body, to mutually engage the insert and the tag body; and
(b) affixing the ear tag to an animal with a locking component, whereby the insecticide will be distributed to the animal over an extended period, controlling ectoparasites present on the animal.

37. The method of claim 36, wherein the extended period is a period of about six months.

38. A method of preparing an animal ear tag for attachment to an animal ear, the method comprising the steps of:
(a) providing a tag body having a receptacle defined therein, the receptacle including a first engagement means;
(b) providing an insert having:
(i) a substantially tubular sidewall having an inner surface, an outer surface, and first and second opposed end portions, the sidewall defining a channel therethrough; and
(ii) a second engagement means for engaging the first engagement means of the tag body, to mutually engage the insert and the tag body; and
(c) placing the insert within the receptacle of the tag body.

39. The method of claim 38, further comprising rotating the insert relative to the tag body, to mutually lock the insert and the tag body.

40. A method for attaching an ear tag to an animal, comprising the steps of:
(a) providing an animal tag comprising:
(i) a tag body having a receptacle defined therein, the receptacle including a first engagement means; and
(ii) an insert having a substantially tubular sidewall having an inner surface, an outer surface, and first and second opposed end portions, the sidewall defining a channel therethrough; and a second engagement means for engaging the first engagement means of the tag body, to mutually engage the insert and the tag body;
(b) providing tagging pliers for attachment of the ear tag;
(c) placing a locking component onto a pin of the tagging pliers;
(d) placing the animal tag onto a respective portion of the tagging pliers;
(e) locating a desired point on an ear of the animal; and
(f) compressing the tagging pliers to insert the locking component into the channel of the insert, thereby mutually engaging the locking component and the tag body.

41. The method of claim 40, further comprising the step of placing the insert within the receptacle of the tag body.
